(19) United States
(12) Patent Application Publication
(10) Pub. No.: US 2007/0290156 A1
(43) Pub. Date: Dec. 20, 2007

(54) Electromagnetically Driven Valve

(76) Inventor: Masahiko Asano, Toyota-shi (JP)

Correspondence Address: KENYON & KENYON LLP, 1500 K STREET N.W., SUITE 700, WASHINGTON, DC, 20005, US

(21) Appl. No.: 11/667,475

(22) PCT Filed: Nov. 25, 2005
(86) PCT No.: PCT/JP05/22144

§ 371 Date: May 10, 2007

(30) Foreign Application Priority Data
Nov. 29, 2004 (JP) 2004-344450

(51) Int. Cl. F16K 31/02

(52) U.S. Cl. 251/129.01

(57) ABSTRACT

An electromagnetically driven valve includes an electromagnet having a coil and generating electromagnetic force, and an upper disc and a lower disc each having a support end and carrying out oscillating movement between a valve-opening position and a valve-closing position around the support end. The upper disc and the lower disc are held at a position intermediate between the valve-opening position and the valve-closing position while the electromagnetic force is not applied. As a result of current supply to the coil, the electromagnetic force in a direction to move the upper disc and the lower disc to the valve-opening position and the valve-closing position acts on each position of the upper disc and the lower disc. The electromagnet is provided such that a distance L1 between the position (X1) and the support end is different from a distance L2 between the position (X2) and the other support end. With such a structure, an electromagnetically driven valve of which initial drive is facilitated is provided.

### TECHNICAL FIELD

The present invention generally relates to an electromagnetically driven valve, and more particularly to an electromagnetically driven valve including an electromagnet implemented by a monocoil.

### BACKGROUND ART

With regard to a conventional electromagnetically driven valve, for example, U.S. Pat. No. 6,467,441 specification discloses an electromagnetic actuator actuating valves of an internal combustion engine as a result of cooperation of electromagnetic force and a spring. The electromagnetic actuator disclosed in this document is called a rotary drive type, in which oscillating movement of a rotatably supported oscillating arm is converted to a linear movement so that a valve carries out reciprocating motion between a valve-opening position and a valve-closing position. An electromagnet consisting of an iron core and a coil wound around the iron core is disposed on each opposing side of the oscillating arm. In order to cause the oscillating arm to oscillate, a current is alternately supplied to these electromagnets so that the electromagnetic force is applied to the oscillating arm from above and below the same.

Japanese Patent Laying-Open No. 2002-115515 discloses an actuator for an electromagnetically driven valve aiming to improve mounting characteristic on a vehicle as well as to achieve lighter weight and cost reduction. In addition, Japanese Patent Laying-Open No. 2001-214764 discloses a valve moving device in an internal combustion engine aiming at suppression of noise or vibration and reduction in power consumption by lowering a speed at which an electromagnet and a moving element collide with each other.

Moreover, Japanese Patent Laying-Open No. 11-141319 discloses an electromagnetically driven valve in an internal combustion engine aiming to realize operation characteristic equal in a valve-opening direction and in a valve-closing direction while supplying an equal exciting current to a pair of electromagnets. The actuator for an electromagnetically driven valve and the like disclosed in Japanese Patent Laying-Open Nos. 2002-115515, 2001-214764 and 11-141319 are called a parallel drive type, in contrast to the rotary drive type disclosed in the specification of U.S. Pat. No. 6,467,441. In such an actuator of a parallel drive type, the electromagnetic force directly acts on a collar-shaped armature provided on a stem of the valve, so as to cause the valve to carry out reciprocating motion.

In the electromagnetic actuator of a rotary drive type disclosed in the specification of U.S. Pat. No. 6,467,441, prior to start moving, the oscillating arm is located at a position intermediate between the valve-opening position and the valve-closing position by elastic force of a torsion bar provided at an oscillation fulcrum of the oscillating arm and elastic force of a helical spring provided in the stem of the valve. When initial drive of the electromagnetic actuator is attempted, a current is supplied to any one of the vertically disposed electromagnets. Then, electromagnetic force attracting the oscillating arm is generated by the electromagnet to which the current is supplied, so that the oscillating arm starts to oscillate.

When the electromagnets disposed above and below the oscillating arm are implemented by a monocoil (a continuous coil) and when the current is supplied to such electromagnets, electromagnetic forces of the same magnitude act on the oscillating arm from above and below. Here, the oscillating arm stays at the intermediate position, and initial drive of the electromagnetic actuator fails.

### DISCLOSURE OF THE INVENTION

The present invention was made to solve the above-described problems, and an object of the present invention is to provide an electromagnetically driven valve of which initial drive is facilitated.

An electromagnetically driven valve according to one aspect of the present invention includes: an electromagnet having a monocoil and generating electromagnetic force; and a moving element having a rotatably supported support portion and carrying out, as a result of action of the electromagnetic force, oscillating movement between a valve-opening position and a valve-closing position around the support portion. The moving element is held at a position intermediate between the valve-opening position and the valve-closing position while the electromagnetic force is not applied. As a result of current supply to the monocoil, the electromagnetic force in a direction to move the moving element to the valve-opening position and the valve-closing position acts on first and second positions of the moving element. The electromagnet is provided such that a distance between the first position and the support portion is different from a distance between the second position and the support portion.

It is noted that a monocoil refers to a continuous coil (the monocoil hereinafter is to be understood similarly). When a current is supplied to the monocoil, the electromagnetic force in a direction to move the moving element to the valve-opening position and the valve-closing position simultaneously acts on the moving element. The position intermediate between the valve-opening position and the valve-closing position refers to a position in the middle between the valve-opening position and valve-closing position where a distance from the valve-opening position is equal to a distance from the valve-closing position (the intermediate position hereinafter is to be understood similarly).

According to the electromagnetically driven valve structured as above, in a state before the moving element starts to move, i.e., in a state in which the moving element is held at the intermediate position, a gap between the electromagnet and the moving element at the first position where the electromagnetic force in the valve-opening direction acts is different from that at the second position where the electromagnetic force in the valve-closing direction acts. Accordingly, as a result of current supply to the monocoil, relatively large electromagnetic force acts on the moving element at a position where the gap between the electromagnet and the moving element is smaller, whereas relatively small electromagnetic force acts on the moving element at a position where the gap between the electromagnet and the moving element is larger. Therefore, the moving element can start to oscillate from the intermediate position, at which the moving element has been held before it starts to move, toward any one of the valve-opening position and the valve-closing position. Initial drive of the electromagnetically driven valve can thus be facilitated.

An electromagnetically driven valve according to another aspect of the present invention includes: an electromagnet having a monocoil and generating electromagnetic force; and a moving element having a rotatably supported support portion and carrying out, as a result of action of the electromagnetic force, oscillating movement between a valve-opening position and a valve-closing position around the support portion. The moving element is held at a position intermediate between the valve-opening position and the valve-closing position while the electromagnetic force is not applied. As a result of current supply to the monocoil, first and second magnetic fluxes generating electromagnetic force in a direction to move the moving element to the valve-opening position and the valve-closing position flow through the moving element. The electromagnet is provided such that the first magnetic flux is different from the second magnetic flux in magnitude.

According to the electromagnetically driven valve structured as above, the electromagnet is provided such that the first magnetic flux generating the electromagnetic force in the valve-opening direction is different in magnitude from the second magnetic flux generating the electromagnetic force in the valve-closing direction. Accordingly, as a result of current supply to the monocoil, relatively large electromagnetic force is generated in the moving element where larger magnetic flux flows, whereas relatively small electromagnetic force is generated in the moving element where smaller magnetic flux flows. Therefore, the moving element can start to oscillate from the intermediate position, at which the moving element has been held before it starts to move, toward any one of the valve-opening position and the valve-closing position. Initial drive of the electromagnetically driven valve can thus be facilitated.

Preferably, the electromagnet further has first and second core portions around which the monocoil is wound such that magnetic circuits through which the first and second magnetic fluxes pass are formed between respective first and second core portions and the moving element. The number of turns of the monocoil wound around the first core portion is different from the number of turns of the monocoil wound around the second core portion. According to the electromagnetically driven valve structured as above, the magnetic flux that flows between the core portion and the moving element is relatively large in the core portion in which the number of turns of monocoil is larger, whereas the magnetic flux that flows between the core portion and the moving element is relatively small in the core portion in which the number of turns of monocoil is smaller. The number of turns of monocoil is thus made different, so that an electromagnetically driven valve of which initial drive is facilitated can be obtained.

Preferably, the electromagnet further has first and second core portions around which the monocoil is wound such that magnetic circuits through which the first and second magnetic fluxes pass are formed between respective first and second core portions and the moving element. Magnetic permeability of a material for forming the first core portion is different from magnetic permeability of a material for forming the second core portion. According to the electromagnetically driven valve structured as above, the magnetic flux that flows between the core portion and the moving element is relatively large in the core portion in which the magnetic permeability is larger, whereas the magnetic flux that flows between the core portion and the moving element is relatively small in the core portion in which the magnetic permeability is smaller. The magnetic permeability of the material for forming the core portion is thus made different, so that an electromagnetically driven valve of which initial drive is facilitated can be obtained.

Preferably, the electromagnet further has first and second core portions around which the monocoil is wound such that magnetic circuits through which the first and second magnetic fluxes pass are formed between respective first and second core portions and the moving element. A minimum cross-sectional area of the first core portion when the first core portion is cut in a plane orthogonal to a direction of flow of the first magnetic flux is different from a minimum cross-sectional area of the second core portion when the second core portion is cut in a plane orthogonal to a direction of flow of the second magnetic flux. According to the electromagnetically driven valve structured as above, the magnetic flux that flows between the core portion and the moving element is relatively large in the core portion having a larger minimum cross-sectional area, whereas the magnetic flux that flows between the core portion and the moving element is relatively small in the core portion having a smaller minimum cross-sectional area. The minimum cross-sectional area of the core portion serving as a passage of the magnetic flux is thus made different, so that an electromagnetically driven valve of which initial drive is facilitated can be obtained.

An electromagnetically driven valve according to yet another aspect of the present invention includes: an electromagnet having a monocoil and generating electromagnetic force; and a moving element having a rotatably supported support portion and carrying out, as a result of action of the electromagnetic force, oscillating movement between a valve-opening position and a valve-closing position around the support portion. The moving element is held at a neutral position between the valve-opening position and the valve-closing position while the electromagnetic force is not applied. As a result of current supply to the monocoil, the electromagnetic force in a direction to move the moving element to the valve-opening position and the valve-closing position acts on the moving element. The neutral position is offset from a position intermediate between the valve-opening position and the valve-closing position toward any one of the valve-opening position and the valve-closing position.

According to the electromagnetically driven valve structured as above, in a state before the moving element starts to move, i.e., in a state in which the moving element is held at the neutral position, the gap between the electromagnet and the moving element at the position at which the electromagnetic force in the valve-opening direction acts is different from that at the position at which the electromagnetic force in the valve-closing direction acts. Accordingly, relatively large electromagnetic force acts on the moving element at the position where the gap between the electromagnet and the moving element is smaller, whereas relatively small electromagnetic force acts on the moving element at the position where the gap between the electromagnet and the moving element is larger. Therefore, the moving element can start to oscillate from the neutral position, at which the moving element has been held before it starts to move, toward any one of the valve-opening position and the valve-closing position. Initial drive of the electromagnetically driven valve can thus be facilitated.

A plurality of moving elements are provided with a space apart from each other. The electromagnet is disposed between the plurality of moving elements. An effect described above can similarly be achieved also in the electromagnetically driven valve adopting such a parallel link mechanism. At the same time, a smaller size of the electromagnetically driven valve can be achieved.

As described above, according to the present invention, an electromagnetically driven valve of which initial drive is facilitated can be provided.

### BRIEF DESCRIPTION OF THE DRAWINGS

FIG. 1 is a cross-sectional view showing an electromagnetically driven valve according to Embodiment 1 of the present invention.

FIG. 2 is a perspective view showing a lower disc (an upper disc) in FIG. 1.

FIG. 3 is a perspective view showing an electromagnet in FIG. 1.

FIG. 4 is a schematic diagram showing a state when the electromagnetically driven valve in FIG. 1 starts to move.

FIG. 5 is a schematic diagram showing an electromagnetically driven valve according to Embodiment 2 of the present invention.

FIG. 6 is a schematic diagram showing a state when the electromagnetically driven valve in FIG. 5 starts to move.

FIG. 7 is a schematic diagram showing an electromagnetically driven valve according to Embodiment 3 of the present invention.

FIG. 8 is a schematic diagram showing a state when the electromagnetically driven valve in FIG. 7 starts to move.

FIG. 9 is a schematic diagram showing an electromagnetically driven valve according to Embodiment 4 of the present invention.

FIG. 10 is a schematic diagram showing a state when the electromagnetically driven valve in FIG. 9 starts to move.

FIG. 11 is a schematic diagram showing an electromagnetically driven valve according to Embodiment 5 of the present invention.

FIG. 12 is a cross-sectional view showing an electromagnetically driven valve according to Embodiment 6 of the present invention.

### BEST MODES FOR CARRYING OUT THE INVENTION

Embodiments of the present invention will be described hereinafter with reference to the drawings. In the drawings referred to hereinafter, the same or corresponding elements have the same reference characters allotted.

### Embodiment 1

The electromagnetically driven valve according to the present embodiment implements an engine valve (an intake valve or an exhaust valve) in an internal combustion engine such as a gasoline engine or a diesel engine. In the present embodiment, description will be given assuming that the electromagnetically driven valve implements an exhaust valve, however, it is noted that the electromagnetically driven valve is similarly structured also when it implements an intake valve.

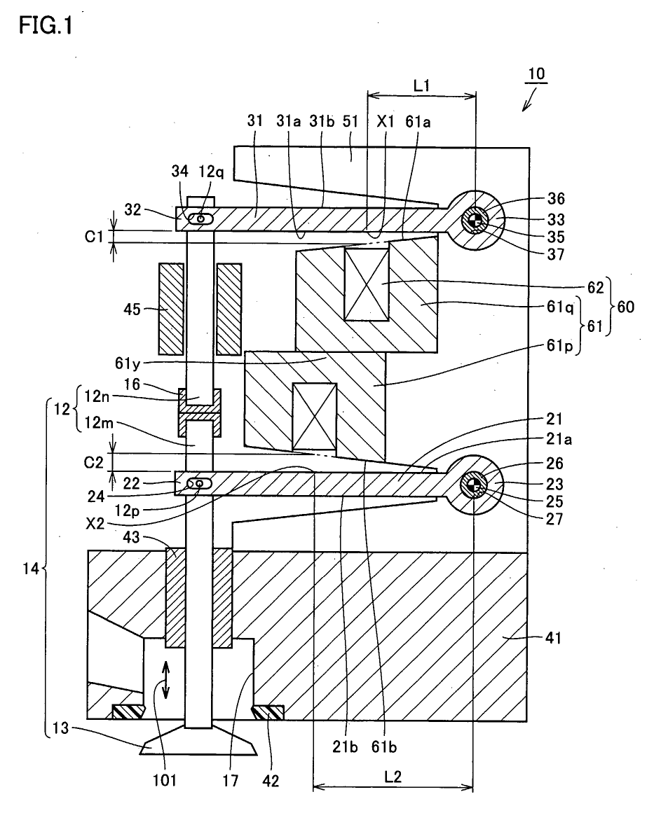

Referring to FIG. 1, an electromagnetically driven valve 10 is a rotary drive type electromagnetically driven valve. As an operation mechanism for the electromagnetically driven valve, a parallel link mechanism is adopted.

Electromagnetically driven valve 10 includes a driven valve 14 having a stem 12 extending in one direction, an upper disc 31 and a lower disc 21 connected to different positions in stem 12 and oscillating by receiving electromagnetic force and elastic force applied thereto, an electromagnet 60 generating the electromagnetic force, and an upper torsion bar 36 and a lower torsion bar 26 provided in upper disc 31 and lower disc 21 respectively and applying elastic force to these discs. Electromagnet 60 is implemented by a coil 62 which is implemented by a monocoil. Driven valve 14 carries out reciprocating motion in a direction in which stem 12 extends (a direction shown with an arrow 101), upon receiving the oscillating movement of upper disc 31 and lower disc 21.

Driven valve 14 is mounted on a cylinder head 41 in which an intake port 17 is formed. A valve seat 42 is provided in a position where intake port 17 of cylinder head 41 communicates to a not-shown combustion chamber. Driven valve 14 further includes an umbrella-shaped portion 13 formed at an end of stem 12. The reciprocating motion of driven valve 14 causes umbrella-shaped portion 13 to intimately contact with valve seat 42 or to move away from valve seat 42, so as to open or close intake port 17. In other words, when stem 12 is elevated, driven valve 14 is positioned at a valve-closing position. On the other hand, when stem 12 is lowered, driven valve 14 is positioned at a valve-opening position.

Stem 12 is constituted of a lower stem 12m continuing from umbrella-shaped portion 13 and an upper stem 12n connected to lower stem 12m with a lash adjuster 16 being interposed. Lash adjuster 16 with a property more likely to contract and less likely to expand attains a function as a buffer member between upper stem 12n and lower stem 12m. Lash adjuster 16 is provided so as to accommodate registration error of driven valve 14 at the valve-closing position, as well as to bring umbrella-shaped portion 13 into contact with valve seat 42 in an ensured manner. Lower stem 12m has a coupling pin 12p projecting from its outer circumferential surface formed, and upper stem 12n has a coupling pin 12q projecting from its outer circumferential surface formed in a position away from coupling pin 12p.

In cylinder head 41, a valve guide 43 for slidably guiding lower stem 12m in an axial direction is provided, and a stem guide 45 for slidably guiding upper stem 12n in an axial direction is provided in a position away from valve guide 43. Valve guide 43 and stem guide 45 are formed from a metal material such as stainless steel, in order to endure high-speed slide movement with respect to stem 12. A disc support base 51 is attached to the top surface of cylinder head 41, in a position apart from stem 12.

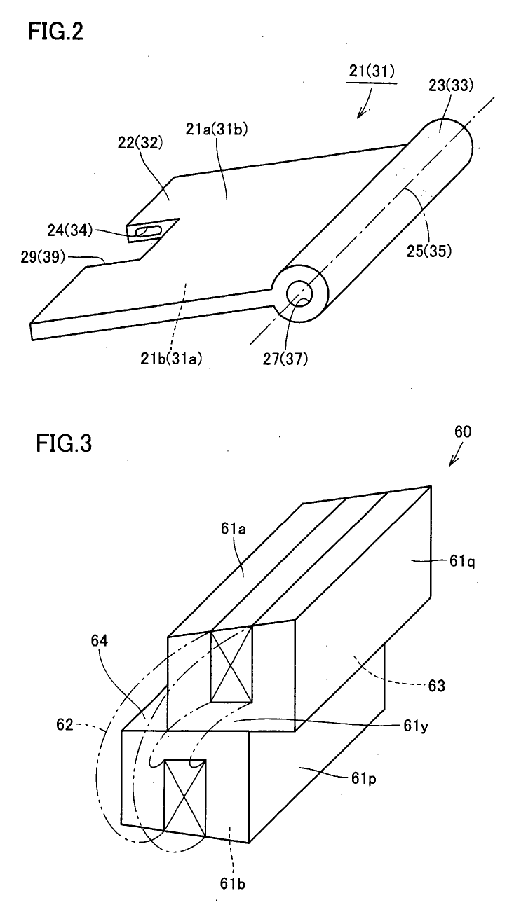

Referring to FIGS. 1 and 2, lower disc 21 has a support end 23 and a coupled end 22, and extends from support end 23 to coupled end 22 in a direction intersecting stem 12. Opposing surfaces 21a and 21b are formed between support end 23 and coupled end 22. A central axis 25 extending in a direction orthogonal to a direction from support end 23 to coupled end 22 and serving as an oscillation center of lower disc 21 is defined in support end 23. Support end 23 has a through hole 27 formed, which extends along central axis 25. A notch 29 is formed in coupled end 22, and elongated holes 24 are formed in opposing wall surfaces of notch 29.

Upper disc 31 is shaped similarly to lower disc 21, and a support end 33, a coupled end 32, a surface 31b, a surface 31a, a notch 39, an elongated hole 34, a through hole 37, and a central axis 35 corresponding to support end 23, coupled end 22, surface 21a, surface 21b, notch 29, elongated hole 24, through hole 27, and central axis 25 of lower disc 21 respectively are formed.

Coupled end 22 of lower disc 21 is coupled to lower stem 12m so as to allow free oscillation of the disc, by insertion of coupling pin 12p into elongated hole 24. Coupled end 32 of upper disc 31 is coupled to upper stem 12n so as to allow free oscillation of the disc, by insertion of coupling pin 12q into elongated hole 34. Support end 23 of lower disc 21 is supported by lower torsion bar 26 inserted in through hole 27 in disc support base 51 so as to allow free oscillation of the disc. Support end 33 of upper disc 31 is supported by upper torsion bar 36 inserted in through hole 37 in disc support base 51 so as to allow free oscillation of the disc. With such a structure, lower disc 21 and upper disc 31 are caused to oscillate around central axes 25 and 35 respectively, so as to cause driven valve 14 to carry out reciprocating motion.

Lower torsion bar 26 applies elastic force to lower disc 21, in a manner moving the same clockwise around central axis 25. Upper torsion bar 36 applies elastic force to upper disc 31, in a manner moving the same counterclockwise around central axis 35. While the electromagnetic force from electromagnet 60 is not yet applied, lower disc 21 and upper disc 31 are positioned by lower torsion bar 26 and upper torsion bar 36 at a position intermediate between the valve-opening position and the valve-closing position.

Referring to FIGS. 1 and 3, electromagnet 60 is provided in disc support base 51 at a position between upper disc 31 and lower disc 21. Electromagnet 60 is constituted of coil 62 implemented by a monocoil and a core 61 formed from a magnetic material, Core 61 has a shaft portion 61y around which coil 62 is wound.

Core 61 is constituted of a valve-opening core 61q facing upper disc 31 and a valve-closing core 61p facing lower disc 21. Assuming a plane extending through the center of shaft portion 61y in parallel to surface 31a and surface 21a, valve-closing core 61p and valve-opening core 61q are vertically symmetrical to each other, with respect to the plane. Valve-closing core 61p and valve-opening core 61q are combined such that they are displaced along the plane in a direction in which lower disc 21 extends from support end 23 to coupled end 22 (in a direction in which upper disc 31 extends from support end 33 to coupled end 32).

Valve-opening core 61q has an attraction and contact surface 61a facing surface 31a, while valve-closing core 61p has an attraction and contact surface 61b facing surface 21a. A position on surface 31a corresponding to the center of attraction and contact surface 61a in a direction from support end 33 to coupled end 32 while upper disc 31 is attracted to attraction and contact surface 61a is denoted as X1, and a position on surface 21a corresponding to the center of attraction and contact surface 61b in a direction from support end 23 to coupled end 22 while lower disc 21 is attracted to attraction and contact surface 61b is denoted as X2. In the present embodiment, the electromagnetic force generated by electromagnet 60 is assumed to act on position X1 of upper disc 31 and position X2 of lower disc 21.

Valve-opening core 61q and valve-closing core 61p are combined with each other such that a distance L1 from central axis 35 at support end 33 to position X1 is smaller than a distance L2 from central axis 25 at support end 23 to position X2. In other words, valve-opening core 61q is provided at a position relatively closer to the oscillation center of upper disc 31 and lower disc 21, while valve-closing core 61p is provided at a position relatively distant from the oscillation center of upper disc 31 and lower disc 21. With such a structure, while upper disc 31 and lower disc 21 are located at the intermediate position, a gap C1 between attraction and contact surface 61a and surface 31a is smaller than a gap C2 between attraction and contact surface 61b and surface 21a.

Valve-opening core 61q and valve-closing core 61p are combined in a manner displaced from each other, so that a surface 64 of valve-closing core 61p is exposed with respect to valve-opening core 61q and a surface 63 of valve-opening core 61q is exposed with respect to valve-closing core 61p. As compared with the core that does not adopt such displaced arrangement, a surface area of core 61 can be increased. Here, cooling performance of electromagnet 60 when electromagnetically driven valve 10 is driven can be improved.

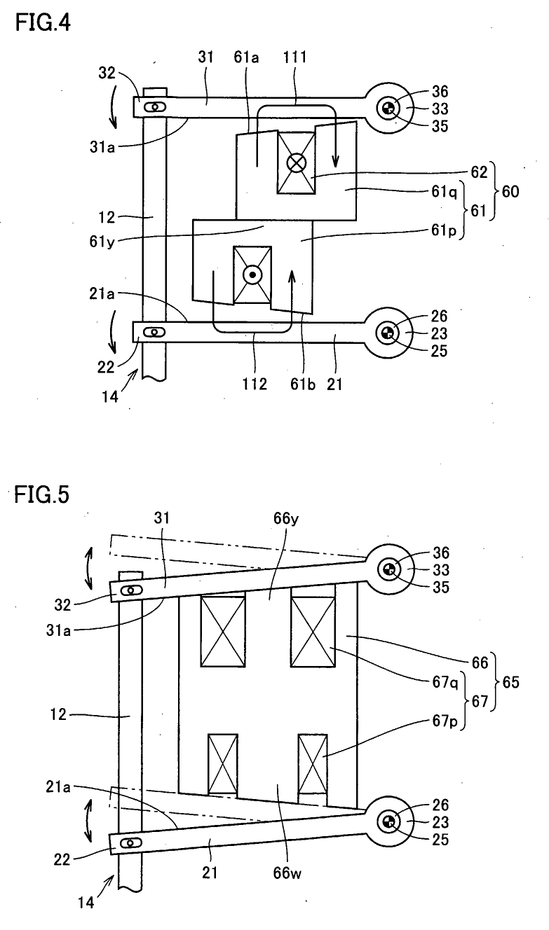

FIGS. 4 to 11 do not show detailed structural elements such as lash adjuster 16 and the like in FIG. 1.

Referring to FIGS. 1 and 4, before electromagnetically driven valve 10 starts to move, upper disc 31 and lower disc 21 are held at the intermediate position by upper torsion bar 36 and lower torsion bar 26. In order to start moving electromagnetically driven valve 10, a current that flows in a prescribed direction is supplied to coil 62 of electromagnet 60. Then, magnetic circuits are formed between valve-opening core 61q and upper disc 31 and between valve-closing core 61p and lower disc 21 respectively, and the magnetic fluxes flow through upper disc 31 and lower disc 21 in directions shown with arrows 111 and 112 respectively.

The electromagnetic force attracting upper disc 31 to attraction and contact surface 61a of electromagnet 60 and the electromagnetic force attracting lower disc 21 to attraction and contact surface 61b of electromagnet 60 are thus generated. The electromagnetic force is relatively large at a position at a smaller distance from electromagnet 60, while the electromagnetic force is relatively small at a position at a larger distance from electromagnet 60. In the present embodiment, as gap C1 between attraction and contact surface 61a and surface 31a is smaller than gap C2 between attraction and contact surface 61b and surface 21a, the electromagnetic force acting on upper disc 31 is larger than the electromagnetic force acting on lower disc 21. Consequently, as a result of current supply to coil 62, upper disc 31 and lower disc 21 start to oscillate toward the valve-opening position against the elastic force of lower torsion bar 26.

Here, upper disc 31 and lower disc 21 are assumed as “levers” that pivot around central axes 35 and 25 respectively. As L1 is smaller than L2 in FIG. 1, the electromagnetic force acting on lower disc 21 acts in turn on stem 12 as the force more effective than the electromagnetic force acting on upper disc 31 in causing driven valve 14 to carry out reciprocating motion. Variation in the electromagnetic force due to varied distance between the electromagnet and the disc, however, is significantly greater than a difference originating from the “principle of leverage” described above. Therefore, driven valve 14 starts to oscillate from the intermediate position toward the valve-opening position when it starts to move.

When driven valve 14 moves from the valve-closing position to the valve-opening position, an in-cylinder pressure due to an expansion stroke is generated in a combustion chamber. Therefore, attraction force sufficiently overcoming the in-cylinder pressure should be generated from electromagnet 60. In the present embodiment, however, upper disc 31 can be attracted to electromagnet 60 with larger electromagnetic force when driven valve 14 moves from the valve-closing position to the valve-opening position. Accordingly, while the current supplied to coil 62 is suppressed to a small value, driven valve 14 can be moved in a stable manner and reduction in power consumption can be achieved. Such an effect can be obtained, in the case of an exhaust valve implemented by driven valve 14, if a direction of oscillation at the time when driven valve 14 starts to move coincides with the direction from the valve-closing position to the valve-opening position. This effect can be achieved similarly in embodiments hereinafter.

Electromagnetically driven valve 10 according to Embodiment 1 of the present invention includes electromagnet 60 having coil 62 implemented by a monocoil and generating the electromagnetic force, and upper disc 31 and lower disc 21 serving as the moving elements that have support ends 33 and 23 serving as the rotatably supported support portions respectively and carry out oscillating movement between the valve-opening position and the valve-closing position around support ends 33 and 23 respectively upon receiving the applied electromagnetic force. While the electromagnetic force is not applied, upper disc 31 and lower disc 21 are held at the position intermediate between the valve-opening position and the valve-closing position. As a result of current supply to coil 62, the electromagnetic force in a direction to move upper disc 31 and lower disc 21 toward the valve-opening position and valve-closing position acts on positions X1 and X2 serving as the first and second positions of upper disc 31 and lower disc 21 respectively. Electromagnet 60 is provided such that distance L1 between position X1 and support end 33 is different from distance L2 between position X2 and support end 23.

According to electromagnetically driven valve 10 in Embodiment 1 of the present invention structured as above, the oscillating movement of upper disc 31 and lower disc 21 can be started simply by supplying a current to coil 62, in spite of coil 62 implemented by a monocoil. Therefore, facilitated initial drive without complicated control can be achieved. In addition, coil 62 implemented by a monocoil is employed, so that the number of expensive parts for the electromagnet can be reduced to half, as compared with an example in which two electromagnets for valve-opening and valve-closing are provided. Moreover, as current supply to coil 62 is merely necessary, the number of circuit elements to be provided in an EDU (electronic driver unit), one circuit element being required for each coil, can also be reduced to half, as in the case of the electromagnet. Therefore, significant cost reduction in manufacturing electromagnetically driven valve 10 can be achieved.

### Embodiment 2

An electromagnetically driven valve according to the present embodiment is structured basically in a manner similar to electromagnetically driven valve 10 in Embodiment 1. Therefore, description of a redundant structure will not be repeated.

Referring to FIG. 5, in the present embodiment, an electromagnet 65 instead of electromagnet 60 in FIG. 1 is disposed between upper disc 31 and lower disc 21. Electromagnet 65 includes a coil 67 implemented by a monocoil and a core 66 formed from a magnetic material. Core 66 has a shaft portion 66y facing upper disc 31 and extending in a direction orthogonal to a direction from support end 33 to coupled end 32 and a shaft portion 66w facing lower disc 21 and extending in a direction orthogonal to a direction from support end 23 to coupled end 22.

Coil 67 is provided in core 66 such that coil 67 is initially wound around shaft portion 66y and further around shaft portion 66w. Coil 67 is constituted of a portion 67q wound around shaft portion 66y and a portion 67p wound around shaft portion 66w. Coil 67 is provided in core 66 such that the number of turns in portion 67q is larger than that in portion 67p. It is noted that the manner of winding coil 67 is not limited as above.

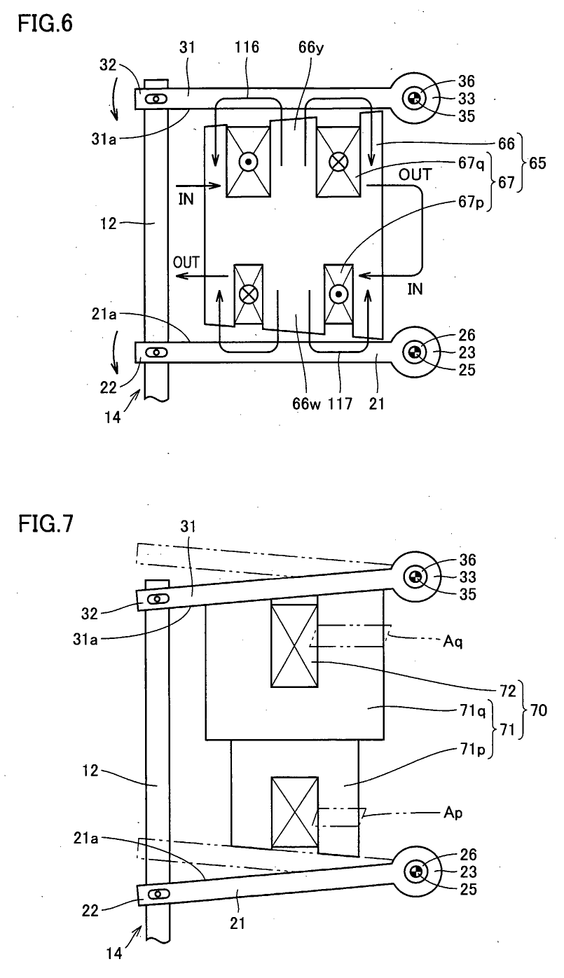

Referring to FIG. 6, in order to start moving the electromagnetically driven valve, a current that flows in a prescribed direction is supplied to coil 67 of electromagnet 65. Then, magnetic circuits are formed between core 66 and upper disc 31 and between core 66 and lower disc 21 respectively, and the magnetic fluxes flow through upper disc 31 and lower disc 21 in directions shown with arrows 116 and 117 respectively. Here, the magnetic flux that flows through upper disc 31 is formed by portion 67q of coil 67 wound around shaft portion 66y, and the magnetic flux that flows through lower disc 21 is formed by portion 67p of coil 67 wound around shaft portion 66w.

Magnetic flux (Φ) is expressed as Φ=(I×N)/Rm, where Rim represents magnetic reluctance of a magnetic circuit, I represents a current and N represents the number of turns of the coil. In the present embodiment, as the number of turns in portion 67q is larger than that in portion 67p, the magnetic flux that flows through upper disc 31 is larger than the magnetic flux that flows through lower disc 21.

Electromagnetic force (F) is expressed as F=Φ²/(μ₀×A), where μ₀ represents magnetic permeability of air, A represents a cross-sectional area of a core and Φ represents a magnetic flux. Therefore, the electromagnetic force acting on upper disc 31 is larger than the electromagnetic force acting on lower disc 21. Consequently, as a result of current supply to coil 67, upper disc 31 and lower disc 21 start to oscillate toward the valve-opening position against the elastic force of lower torsion bar 26.

In the electromagnetically driven valve according to Embodiment 2 of the present invention, electromagnet 65 further has shaft portion 66y and shaft portion 66w serving as the first and second core portions, around which coil 67 implemented by the monocoil is wound such that magnetic circuits through which the magnetic fluxes pass in the directions shown with arrows 116 and 117 are formed between shaft portion 66y, shaft portion 66w and upper disc 31, lower disc 21 respectively. The number of turns of coil 67 wound around shaft portion 66y is different from the number of turns of coil 67 wound around shaft portion 66w.

According to the electromagnetically driven valve in Embodiment 2 of the present invention structured as above, an effect similar to that in Embodiment 1 can be obtained.

### Embodiment 3

An electromagnetically driven valve according to the present embodiment is structured basically in a manner similar to electromagnetically driven valve 10 in Embodiment 1. Therefore, description of a redundant structure will not be repeated.

Referring to FIG. 7, in the present embodiment, an electromagnet 70 instead of electromagnet 60 in FIG. 1 is disposed between upper disc 31 and lower disc 21. Electromagnet 70 includes a coil 72 implemented by a monocoil and a core 71 formed from a magnetic material. Core 71 is constituted of a valve-opening core 71q facing upper disc 31 and a valve-closing core 71p facing lower disc 21. Core 71 is formed such that a minimum cross-sectional area Aq when valve-opening core 71q is cut in a plane orthogonal to a direction of flow of the magnetic flux is larger than a minimum cross-sectional area Ap when valve-closing core 71p is cut in a plane orthogonal to the direction of flow of the magnetic flux.

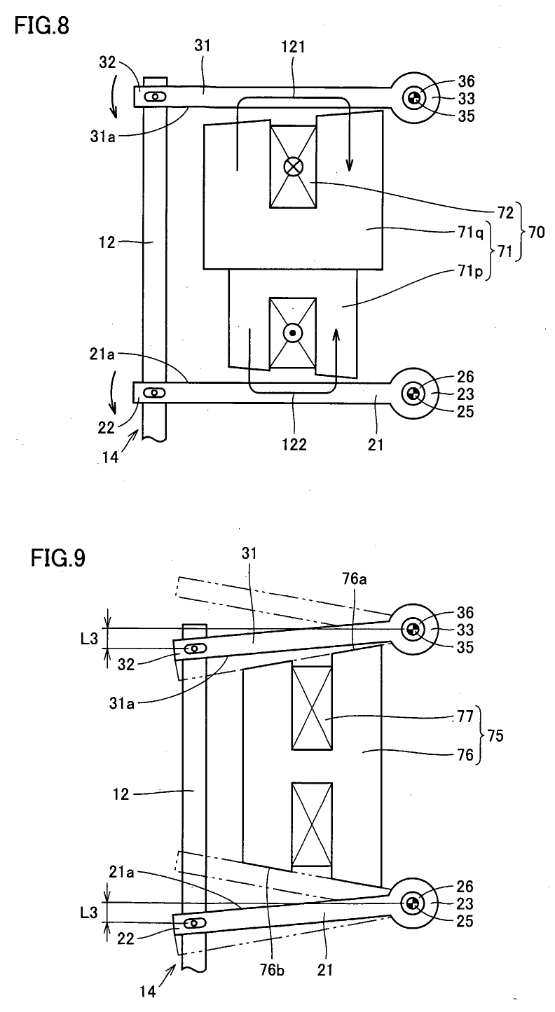

Referring to FIG. 8, in order to start moving the electromagnetically driven valve, a current that flows in a prescribed direction is supplied to coil 72 of electromagnet 70. Then, magnetic circuits are formed between valve-opening core 71q and upper disc 31 and between valve-closing core 71p and lower disc 21 respectively, and the magnetic fluxes flow through upper disc 31 and lower disc 21 in directions shown with arrows 121 and 122 respectively.

Magnetic flux (Φ) is expressed as Φ=B×A, where B represents magnetic flux density and A represents a cross-sectional area of the core. In the present embodiment, as minimum cross-sectional area Aq of valve-opening core 71q is larger than minimum cross-sectional area Ap of valve-closing core 71p, the magnetic flux that flows through upper disc 31 is larger than the magnetic flux that flows through lower disc 21. Therefore, the electromagnetic force acting on upper disc 31 is larger than the electromagnetic force acting on lower disc 21. Consequently, as a result of current supply to coil 72, upper disc 31 and lower disc 21 start to oscillate toward the valve-opening position against the elastic force of lower torsion bar 26.

In order to achieve the magnetic flux flowing through upper disc 31 larger than the magnetic flux flowing through lower disc 21, valve-opening core 71q may be formed from a material having relatively large magnetic permeability, and valve-closing core 71p may be formed from a material having relatively small magnetic permeability. Here, the magnetic flux flows through valve-opening core 71q more easily than through valve-closing core 71p. Upper disc 31 and lower disc 21 can thus be caused to oscillate toward the valve-opening position, as a result of current supply to coil 72.

In the electromagnetically driven valve according to Embodiment 3 of the present invention, electromagnet 70 further has valve-opening core 71q and valve-closing core 71p serving as the first and second core portions, around which coil 72 implemented by the monocoil is wound such that magnetic circuits through which the magnetic fluxes pass in the directions shown with arrows 121 and 122 are formed between valve-opening core 71q, valve-closing core 71p and upper disc 31, lower disc 21 respectively. Minimum cross-sectional area Aq of valve-opening core 71q when it is cut in the plane orthogonal to the direction shown with arrow 121 is different from minimum cross-sectional area Ap of valve-closing core 71p when it is cut in the plane orthogonal to the direction shown with arrow 122. Alternatively, the magnetic permeability of the material for forming valve-opening core 71q is different from the magnetic permeability of the material for forming valve-closing core 71p.

According to the electromagnetically driven valve in Embodiment 3 of the present invention structured as above, an effect similar to that in Embodiment 1 can be obtained.

The structures of the electromagnet described in Embodiments 1 to 3 may be combined as appropriate, to implement the electromagnetically driven valve.

### Embodiment 4

An electromagnetically driven valve according to the present embodiment is structured basically in a manner similar to electromagnetically driven valve 10 in Embodiment 1. Therefore, description of a redundant structure will not be repeated.

Referring to FIG. 9, in the present embodiment, an electromagnet 75 instead of electromagnet 60 in FIG. 1 is disposed between upper disc 31 and lower disc 21. Electromagnet 75 includes a coil 77 implemented by a monocoil and a core 76 formed from a magnetic material. Electromagnet 75 has a vertically symmetrical shape, with respect to a plane extending in parallel to upper disc 31 and lower disc 21 between the same. In other words, electromagnet 75 has a similar shape on an upper disc 31 side and a lower disc 21 side, with respect to the plane. Electromagnet 75 has an attraction and contact surface 76a facing surface 31a of upper disc 31 and an attraction and contact surface 76b facing surface 21a of lower disc 21.

While the electromagnetic force from electromagnet 75 is not applied, upper disc 31 and lower disc 21 are positioned at a neutral position in FIG. 9 by upper torsion bar 36 and lower torsion bar 26. The neutral position is displaced from the position intermediate between the valve-opening position and the valve-closing position toward the valve-opening position by a distance L3 in a direction of reciprocating motion of driven valve 14. With such a structure, while upper disc 31 and lower disc 21 are positioned at the neutral position, a gap between surface 31a of upper disc 31 and attraction and contact surface 76a of electromagnet 75 is smaller than a gap between surface 21a of lower disc 21 and attraction and contact surface 76b of electromagnet 75.

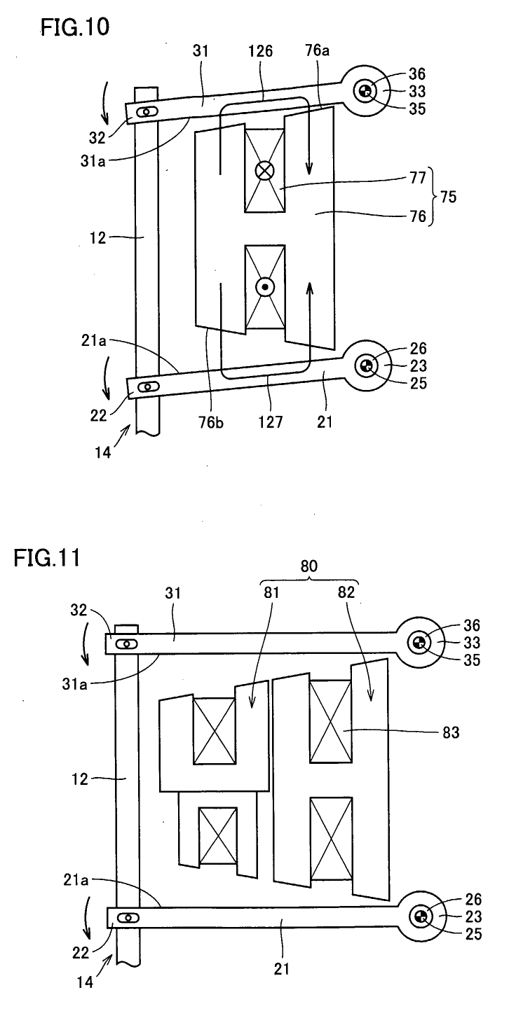

Referring to FIG. 10, in order to start moving the electromagnetically driven valve, a current that flows in a prescribed direction is supplied to coil 77 of electromagnet 75. Then, magnetic circuits are formed between core 76 and upper disc 31 and between core 76 and lower disc 21 respectively, and the magnetic fluxes flow through upper disc 31 and lower disc 21 in directions shown with arrows 126 and 127 respectively.

In this manner, the electromagnetic force attracting upper disc 31 to attraction and contact surface 76a of electromagnet 75 and the electromagnetic force attracting lower disc 21 to attraction and contact surface 76b of electromagnet 75 are generated. In the present embodiment, as the gap between attraction and contact surface 76a and surface 31a is smaller than the gap between attraction and contact surface 76b and surface 21a, the electromagnetic force acting on upper disc 31 is larger than the electromagnetic force acting on lower disc 21. Consequently, as a result of current supply to coil 77, upper disc 31 and lower disc 21 start to oscillate toward the valve-opening position against the elastic force of lower torsion bar 26.

In the electromagnetically driven valve according to Embodiment 4 of the present invention, while the electromagnetic force is not applied, upper disc 31 and lower disc 21 are held at the neutral position between the valve-opening position and the valve-closing position. As a result of current supply to coil 77 implemented by the monocoil, the electromagnetic force in the direction to move upper disc 31 and lower disc 21 toward the valve-opening position and the valve-closing position acts on upper disc 31 and lower disc 21. The neutral position is offset from the position intermediate between the valve-opening position and the valve-closing position toward any one of the valve-opening position and the valve-closing position.

According to the electromagnetically driven valve in Embodiment 4 of the present invention structured as above, an effect similar to that in Embodiment 1 can be obtained.

It is noted that the electromagnetically driven valve according to Embodiment 4 may be implemented by appropriately incorporating the electromagnet described in Embodiments 1 to 3.

### Embodiment 5

Referring to FIG. 11, in the present embodiment, an electromagnet 80 instead of electromagnet 60 in FIG. 1 is disposed between upper disc 31 and lower disc 21. Electromagnet 80 is implemented by combination of an electromagnet 81 disposed at a position relatively closer to driven valve 14 and an electromagnet 82 disposed at a position relatively distant from driven valve 14. Electromagnet 81 is in a shape similar to any one of electromagnets 60, 65 and 70 in Embodiments 1 to 3, while electromagnet 82 is in a shape similar to electromagnet 75 in Embodiment 4. A coil 83 implemented by a monocoil is wound around electromagnets 81 and 82. It is noted that the manner of winding coil 83 is not limited to a specific manner, and coil 83 may be wound in any of vertical and horizontal directions in FIG. 11.

According to the electromagnetically driven valve in Embodiment 5 of the present invention structured as above, an effect similar to that in Embodiment 1 can be obtained. In addition, electromagnet 82 is combined with electromagnet 81, so that the electromagnetic force applied to upper disc 31 and lower disc 21 can be increased.

Improvement in driving force can thus be achieved.

### Embodiment 6

An electromagnetically driven valve according to the present embodiment is structured basically in a manner similar to electromagnetically driven valve 10 in Embodiment 1. Therefore, description of a redundant structure will not be repeated.

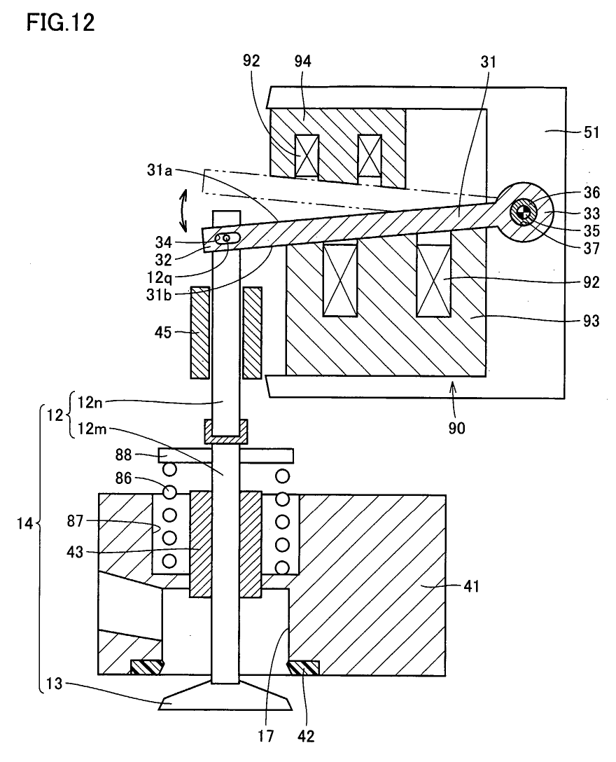

Referring to FIG. 12, in the present embodiment, lower disc 21 in FIG. 1 is not provided and solely upper disc 31 is provided. A collar-shaped lower retainer 88 is provided on an outer circumferential surface of lower stem 12m. In cylinder head 41, an opening 87 opening toward a top surface is formed. Opening 87 accommodates a lower spring 86 such that lower spring 86 is sandwiched between a bottom surface of opening 87 and lower retainer 88. Lower spring 86 moves driven valve 14 toward the valve-closing position, instead of lower torsion bar 26 in FIG. 1.

An electromagnet 90 is attached to disc support base 51. Electromagnet 90 is constituted of a valve-closing core 94 and a valve-opening core 93 positioned above and below upper disc 31 respectively and a coil 92 implemented by a monocoil wound around these cores. Valve-closing core 94 and valve-opening core 93 are different from each other in a distance between support end 33 and the core, the number of turns of coil 92, a minimum cross-sectional area of the core, and magnetic permeability of a core material, as in electromagnets 60, 65 and 70 in Embodiments 1 to 3. The electromagnetically driven valve may be formed such that, even if electromagnet 90 is not formed in the above-described manner, upper disc 31 is held at the neutral position described in Embodiment 4 by upper torsion bar 36 and lower spring 86 when it starts to move.

According to the electromagnetically driven valve in Embodiment 6 of the present invention structured as above, an effect similar to that in Embodiment 1 can be obtained.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The present invention is mainly utilized as an intake valve (or an exhaust valve) in a gasoline engine, a diesel engine, or the like.

1. An electromagnetically driven valve, comprising:
an electromagnet having a monocoil and generating electromagnetic force; and
a moving element having a rotatably supported support portion and carrying out, as a result of action of said electromagnetic force, oscillating movement between a valve-opening position and a valve-closing position around said support portion; wherein
said moving element is held at a position intermediate between said valve-opening position and said valve-closing position while said electromagnetic force is not applied, and as a result of current supply to said monocoil, the electromagnetic force in a direction to move said moving element to said valve-opening position and said valve-closing position acts on first and second positions of said moving element, and
said electromagnet is provided such that a distance between said first position and said support portion is different from a distance between said second position and said support portion
said electromagnet has a valve-opening core attracting said moving element to said valve-opening position, around which said monocoil is wound, and a valve-closing core attracting said moving element to said valve-closing position, around which said monocoil is wound.

2. The electromagnetically driven valve according to claim 1, wherein
a plurality of said moving elements are provided with a space apart from each other, and
said electromagnet is disposed between said plurality of moving elements.

3. An electromagnetically driven valve comprising:
an electromagnet having a monocoil and generating electromagnetic force; and
a moving element having a rotatably supported support portion and carrying out, as a result of action of said electromagnetic force, oscillating movement between a valve-opening position and a valve-closing position around said support portion; wherein
said moving element is held at a position intermediate between said valve-opening position and said valve-closing position while said electromagnetic force is not applied, and as a result of current supply to said monocoil, first and second magnetic fluxes generating electromagnetic force in a direction to move said moving element to said valve-opening position and said valve-closing position flow through said moving element, and
said electromagnet is provided such that said first magnetic flux is different from said second magnetic flux in magnitude, and
said electromagnet further has first and second core portions around which said monocoil is wound, such that magnetic circuits through which said first and second magnetic fluxes pass are formed between respective said first and second core portions and said moving element.

4. The electromagnetically driven valve according to claim 3, wherein
number of turns of said monocoil wound around said first core portion is different from number of turns of said monocoil wound around said second core portion.

5. The electromagnetically driven valve according to claim 3, wherein
magnetic permeability of a material for forming said first core portion is different from magnetic permeability of a material for forming said second core portion.

6. The electromagnetically driven valve according to claim 3, wherein
a minimum cross-sectional area of said first core portion when said first core portion is cut in a plane orthogonal to a direction of flow of said first magnetic flux is different from a minimum cross-sectional area of said second core portion when said second core portion is cut in a plane orthogonal to a direction of flow of said second magnetic flux.

7. The electromagnetically driven valve according to claim 3, wherein
a plurality of said moving elements are provided with a space apart from each other, and
said electromagnet is disposed between said plurality of moving elements.

8. An electromagnetically driven valve, comprising:
an electromagnet having a monocoil and generating electromagnetic force; and
a moving element having a rotatably supported support portion and carrying out, as a result of action of said electromagnetic force, oscillating movement between a valve-opening position and a valve-closing position around said support portion; wherein
said moving element is held at a neutral position between said valve-opening position and said valve-closing position while said electromagnetic force is not applied, and as a result of current supply to said monocoil, the electromagnetic force in a direction to move said moving element to said valve-opening position and said valve-closing position acts on said moving element, and
said neutral position is offset from a position intermediate between said valve-opening position and said valve-closing position toward any one of said valve-opening position and said valve-closing position, and
said electromagnet has a symmetrical shape with respect to a plane extending in parallel to said moving element located at said intermediate position.

9. The electromagnetically driven valve according to claim 8, wherein
a plurality of said moving elements are provided with a space apart from each other, and
said electromagnet is disposed between said plurality of moving elements.
